(19) United States
(12) Patent Application Publication
(10) Pub. No.: US 2018/0332651 A1
(43) Pub. Date: Nov. 15, 2018

(54) Device and Method of Performing a Modification Procedure

(71) Applicant: HTC Corporation, Taoyuan City (TW)

(72) Inventor: Jing-Rong Hsieh, Taoyuan City (TW)

(21) Appl. No.: 15/975,782

(22) Filed: May 10, 2018

Related U.S. Application Data
(60) Provisional application No. 62/505,131, filed on May 12, 2017.

(51) Int. Cl. H04W 76/20; H04W 76/15

(52) U.S. Cl. CPC H04W 76/20; H04W 92/20; H04W 76/15

(57) ABSTRACT

A secondary base station (BS) for performing a modification procedure with a master BS comprises a storage device for storing instructions and a processing circuit coupled to the storage device. The storage device stores, and the processing circuit is configured to execute instructions of transmitting a first message comprising a first radio resource control (RRC) message and a secondary BS configuration to the master BS, wherein the secondary BS configuration comprises a plurality of configuration parameters; modifying the secondary BS configuration to a modified secondary BS configuration according to a master BS configuration, when receiving a second message comprising the master BS configuration from the master BS in response to the first message; and transmitting the modified secondary BS configuration to the master BS.

### CROSS REFERENCE TO RELATED APPLICATIONS

This application claims the benefit of U.S. Provisional Application No. 62/505,131, filed on May 12, 2017, which is incorporated herein by reference.

### BACKGROUND OF THE INVENTION

### 1. Field of the Invention

The present invention relates to a device and a method used in a wireless communication system, and more particularly, to a device and a method of performing a modification procedure.

### 2. Description of the Prior Art

A fifth generation (5G) (or called new radio (NR)) system provides higher data rate and lower latency for data transmission than those of a long-term evolution (LTE) system. A radio access network (RAN) in the LTE system includes at least one base station (BS) for communicating with at least one user equipment (UE) and for communicating with a core network. The core network may be responsible for a mobility management and a Quality of Service (QoS) control of the at least one UE.

### SUMMARY OF THE INVENTION

The present invention therefore provides a communication device and method for performing a modification procedure to solve the abovementioned problem.

A secondary base station (BS) for performing a modification procedure with a master BS comprises a storage device for storing instructions and a processing circuit coupled to the storage device. The storage device stores, and the processing circuit is configured to execute instructions of transmitting a first message comprising a first radio resource control (RRC) message and a secondary BS configuration to the master BS, wherein the secondary BS configuration comprises a plurality of configuration parameters; modifying the secondary BS configuration to a modified secondary BS configuration according to a master BS configuration, when receiving a second message comprising the master BS configuration from the master BS in response to the first message; and transmitting the modified secondary BS configuration to the master BS.

A master base station (BS) for performing a modification procedure with a secondary BS comprises a storage device for storing instructions and a processing circuit coupled to the storage device. The storage device stores, and the processing circuit is configured to execute instructions of receiving a first message comprising a first radio resource control (RRC) message and a secondary BS configuration from the secondary BS, wherein the secondary BS configuration comprises a plurality of configuration parameters; transmitting a second message comprising a master BS configuration to the secondary BS in response to the first message and, when determining that the modification for the secondary BS configuration is needed according to the plurality of configuration parameters; and receiving a modified secondary BS configuration from the secondary BS in response to the second message.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a wireless communication system according to an example of the present invention.

FIG. 2 is a schematic diagram of a communication device according to an example of the present invention.

FIG. 3 is a flowchart of a process according to an example of the present invention.

FIG. 4 is a flowchart of a process according to an example of the present invention.

FIG. 5 is a schematic diagram of a modification procedure according to an example of the present invention.

### DETAILED DESCRIPTION

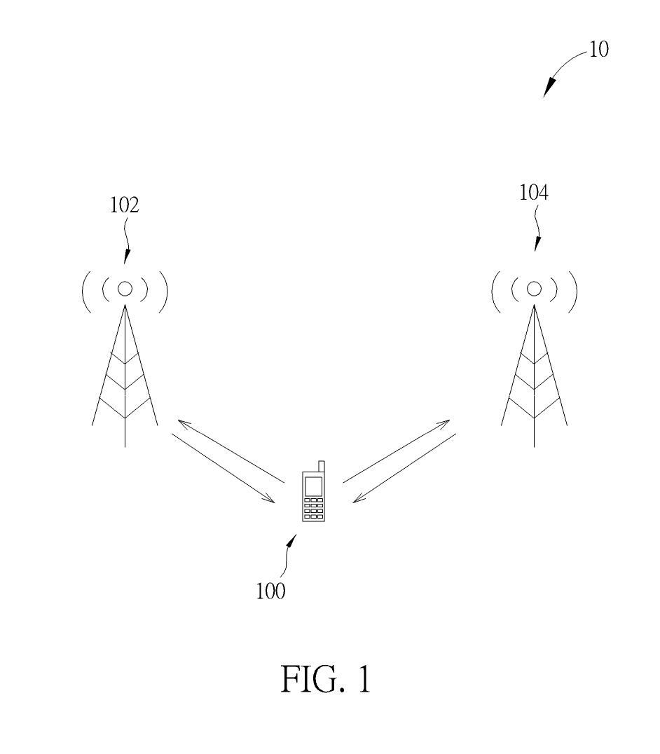

FIG. 1 is a schematic diagram of a wireless communication system 10 according to an example of the present invention. The wireless communication system 10 is briefly composed of a communication device 100, a base station (BS) 102 and a BS 104. In FIG. 1, the communication device 100, the BS 102 and the BS 104 are simply utilized for illustrating the structure of the wireless communication system 10. In FIG. 1, coverage areas of the BS 102 and the BS 104 may be partly overlapped.

In FIG. 1, the communication device 100 may be configured to communicate with the BS 102 and the BS 104 simultaneously according to a dual connectivity (DC) configured to the communication device 100. That is, the communication device 100 may perform a transmission/reception via both the BS 102 and the BS 104, e.g., at different carrier frequencies. For example, the communication device 100 may receive packets (e.g., protocol data units (PDUs)) from the BS 102 atone carrier frequency and from the BS 104 at another carrier frequency, or the communication device 100 may transmit packets (e.g., PDUs) to the BS 102 at one carrier frequency and to the BS 104 at another carrier frequency. In addition, one of the BS 102 and the BS 104 may be a master BS (i.e., a master node (MN)), and the other one of the BS 102 and the BS 104 may be a secondary BS (i.e., a secondary node (SN)). The BS 102 and the BS 104 may operate according to different radio access technologies (RATs). For example, one of the BS 102 and the BS 104 operates in a long-term evolution (LTE) system, and the other one of the BS 102 and the BS 104 operates in a new radio (NR) (or called fifth generation (5G)) system.

A communication device may be a user equipment (UE), a mobile phone, a laptop, a tablet computer, an electronic book, a portable computer system, a vehicle, a ship or an aircraft. In addition, the BS(s) and the communication device can be seen as a transmitter or a receiver according to direction (i.e., transmission direction), e.g., for an uplink (UL) , the communication device is the transmitter and the BS (s) is/are the receiver, and for a downlink (DL), the BS (s) is/are the transmitter and the communication device is the receiver.

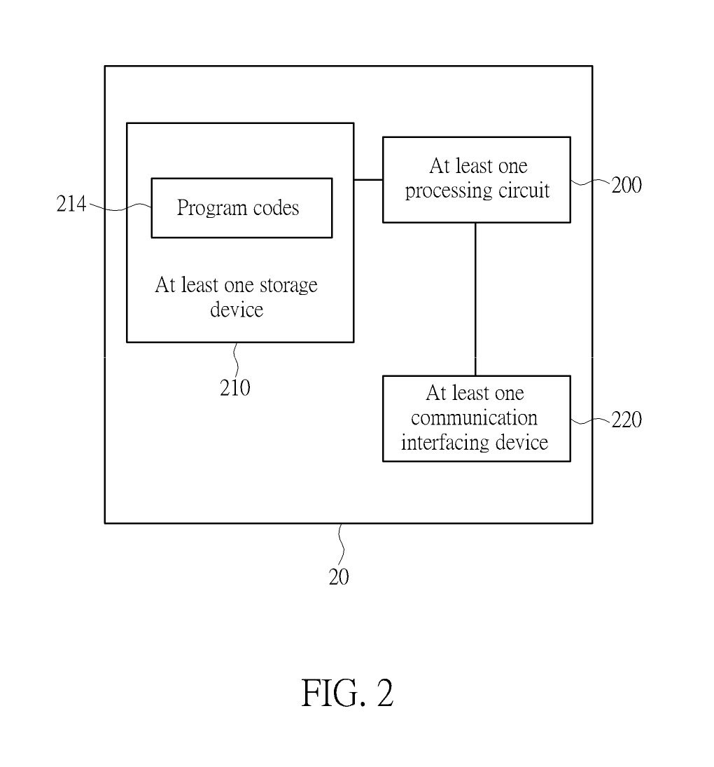

FIG. 2 is a schematic diagram of a communication device 20 according to an example of the present invention. The communication device 20 may be any of the communication device 100, the BS 102 or the BS 104 shown in FIG. 1, but is not limited herein. The communication device 20 may include at least one processing circuit 200 such as a microprocessor or Application Specific Integrated Circuit (ASIC), at least one storage device 210 and at least one communication interfacing device 220. The at least one storage device 210 may be any data storage device that may store program codes 214, accessed and executed by the at least one processing circuit 200. Examples of the at least one storage device 210 include but are not limited to a subscriber identity module (SIM), read-only memory (ROM), flash memory, random-access memory (RAM), hard disk, optical data storage device, non-volatile storage device, non-transitory computer-readable medium (e.g., tangible media), etc. The at least one communication interfacing device 220 includes at least one transceiver and is used to transmit and receive signals (e.g., data, messages and/or packets) according to processing results of the at least one processing circuit 200.

In a Multi Radio Access Technology (RAT) DC (MR-DC), a MN and a SN (e.g., the BS 102 and the BS 104) operate according to different RATs. The MN may understand a part of secondary BS configuration (e.g., SCG-Config) and may not understand a SN RRC message, wherein the secondary BS configuration and the SN RRC message are received from the SN. The SCG-Config includes a SCG-ConfigPartSCG which includes a RadioResourceConfigDedicatedSCG, and the RadioResourceConfigDedicatedSCG further includes a drb-ToAddModListSCG (e.g., an addition or modification list of data radio bearers (DRBs) for secondary cell group (SCG)). Thus, how to improve the coordination between the MN and the SN is an important problem to be solved.

In the following examples, a UE is used to represent the communication device 100 in FIG. 1, to simplify the illustration of the embodiments.

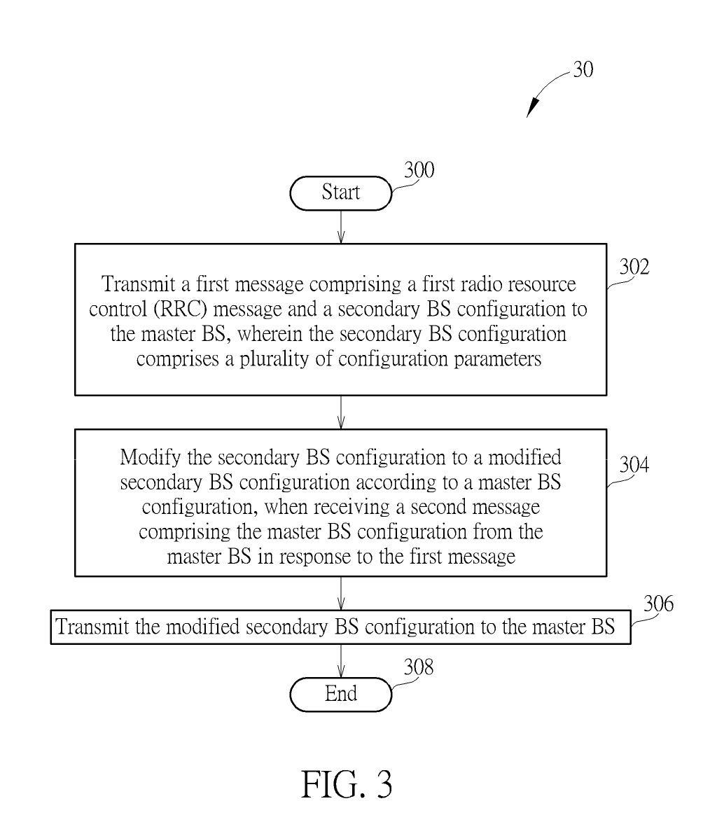

A process 30 in FIG. 3 is utilized in a secondary BS (e.g., the BS 104 in FIG. 1), for performing a modification procedure with a master BS (e.g., the BS 102 in FIG. 1), and includes the following steps:

Step 300: Start.

Step 302: Transmit a first message comprising a first radio resource control (RRC) message and a secondary BS configuration to the master BS, wherein the secondary BS configuration comprises a plurality of configuration parameters.

Step 304: Modify the secondary BS configuration to a modified secondary BS configuration according to a master BS configuration, when receiving a second message comprising the master BS configuration from the master BS in response to the first message.

Step 306: Transmit the modified secondary BS configuration to the master BS.

Step 308: End

According to the process 30, the secondary BS transmits a first message comprising a first RRC message and a secondary BS configuration (e.g., SCG-Config) to the master BS, wherein the secondary BS configuration comprises a plurality of configuration parameters (e.g., drb-ToAddModListSCG). The master BS transmits a second message comprising a master BS configuration to the secondary BS, when determining that a modification for the secondary BS configuration is needed according to the plurality of configuration parameters. Then, the secondary BS modifies the secondary BS configuration to a modified secondary BS configuration according to the master BS configuration, when receiving the second message from the master BS in response to the first message. The secondary BS transmits the modified secondary BS configuration to the master BS. The secondary BS configuration and the modified secondary BS configuration may include the plurality of configuration parameters (e.g., drb-ToAddModListSCG) for the master BS to check or understand information in the first RRC message. Thus, the master BS comprehends the information in the first RRC message, and the coordination between the master BS and the secondary BS is improved.

Realization of the process 30 is not limited to the above description. The following examples may be applied to the process 30.

In one example, the plurality of configuration parameters include a list of DRBs for the secondary BS to be added or modified by the secondary BS. In one example, the first RRC message includes a plurality of configurations for a UE to configure at least one of a Physical layer, a Medium Access Control (MAC) layer and a Radio Link Control (RLC) layer. That is, the UE communicates with the secondary BS according to the plurality of configurations in the first RRC message. In one example, the first message is a SN Modification Required message, and the second message is a SN Modification Request message. In one example, the master BS configuration includes at least one RB configuration of the master BS. In one example, the secondary BS configuration is SCG-Config, and the master BS configuration is SCG-ConfigInfo or mcg-RB-Config which is the RB configuration of the master BS.

In one example, the secondary BS modifies the first RRC message to a modified RRC message according to the master BS configuration which includes the RB configuration (e.g., mcg-RB-Config) of the master BS, when receiving the second message including the master BS configuration from the master BS in response to the first message. Then, the secondary BS transmits the modified RRC message to the master BS. In one example, the modified RRC message includes a plurality of configurations for the UE to configure at least one of the Physical layer, the MAC layer and the RLC layer. That is, the UE communicates with the secondary BS according to the plurality of configurations in the modified RRC message.

In one example, the master BS is a LTE BS (e.g., eNB), and the secondary BS is a NR BS (e.g., gNB). In one example, the master BS is a NR BS (e.g., gNB), and the secondary BS is a LTE BS (e.g., eNB). In one example, the modification procedure is initiated by the master BS or the secondary BS. When the modification procedure is initiated, the secondary BS transmits the first message including at least one of the secondary BS configuration (e.g., drb-ToAddModListSCG) and the first RRC message to the master BS.

In one example, the secondary BS transmits a third message including the secondary BS configuration (e.g., drb-ToAddModListSCG) to the master BS, wherein the third message does not include the first RRC message. In one example, the condition that the coordination is needed is determined according to pre-defined messages, pre-defined configurations, or a negotiation between the master BS and the secondary BS before the modification procedure is initiated.

In one example, the secondary BS transmits a fourth message including a fourth RRC message to the master BS. Then, the master BS receives the fourth message, and generates a fifth RRC message including the fourth RRC message. The master BS transmits the fifth RRC message to a UE. In this situation, the coordination between the master BS and the secondary BS is not needed. That is, the master BS may not understand information in the fourth RRC message. In one example, the condition that the coordination is not needed is determined according to pre-defined messages, pre-defined configurations, or a negotiation between the master BS and the secondary BS before the modification procedure is initiated.

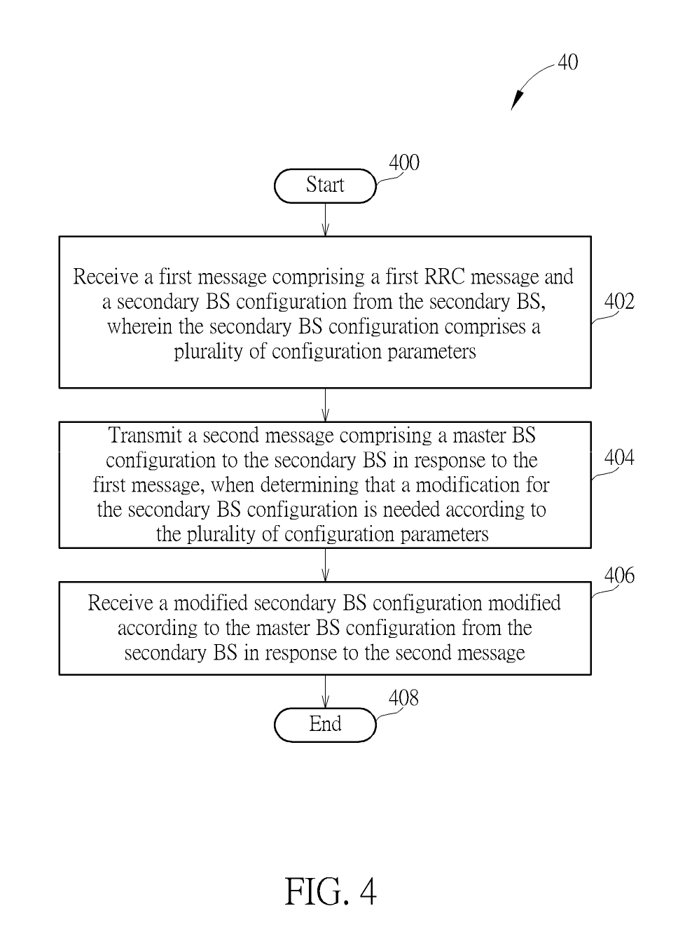

A process 40 in FIG. 4 is utilized in a master BS (e.g., the BS 102 in FIG. 1), for performing a modification procedure with a secondary BS (e.g., the BS 104 in FIG. 1), and includes the following steps:

Step 400: Start.

Step 402: Receive a first message comprising a first RRC message and a secondary BS configuration from the secondary BS, wherein the secondary BS configuration comprises a plurality of configuration parameters.

Step 404: Transmit a second message comprising a master BS configuration to the secondary BS in response to the first message, when determining that a modification for the secondary BS configuration is needed according to the plurality of configuration parameters.

Step 406: Receive a modified secondary BS configuration from the secondary BS in response to the second message.

Step 408: End

According to the process 40, the master BS receives a first message comprising a first RRC message and a secondary BS configuration from the secondary BS, wherein the secondary BS configuration comprises a plurality of configuration parameters (e.g., drb-ToAddModListSCG). Then, the master BS transmits a second message comprising a master BS configuration to the secondary BS in response to the first message, when determining that a modification for the secondary BS configuration is needed according to the plurality of configuration parameters. The master BS receives a modified secondary BS configuration from the secondary BS in response to the second message. The secondary BS configuration and the modified secondary BS configuration may include the plurality of configuration parameters (e.g., drb-ToAddModListSCG) for the master BS to check or understand information in the first RRC message. Thus, the master BS comprehends the information in the first RRC message, and the coordination between the master BS and the secondary BS is improved.

Realization of the process 40 is not limited to the above description. The following examples may be applied to the process 40.

In one example, the plurality of configuration parameters include a list of DRBs for the secondary BS to be added or modified by the secondary BS. In one example, the first RRC message includes a plurality of configurations for a UE to configure at least one of a Physical layer, a MAC layer and a RLC layer. That is, the UE communicates with the secondary BS according to the plurality of configurations in the first RRC message. In one example, the first message is a SN Modification Required message, and the second message is a SN Modification Request message. In one example, the master BS configuration includes at least one RB configuration of the master BS. In one example, the secondary BS configuration is SCG-Config, and the master BS configuration is SCG-ConfigInfo or mcg-RB-Config which is the RB configuration of the master BS.

In one example, the master BS generates a second RRC message including (e.g., encapsulating) the first RRC message. Then, the master BS transmits the second message to a UE. In one example, the secondary BS modifies the first RRC message to a modified RRC message according to the master BS configuration, and transmits the modified RRC message to the master BS. Then, the master BS generates a second RRC message including the modified RRC message, and transmits the second message to the UE. In one example, the master BS transmits a third message with an appropriate cause value indicating that the modification is needed to the secondary BS, if the master BS does not transmit the second message. In one example, the third message is a SN Modification Refuse message. In one example, the master BS configures the UE according to the secondary BS configuration.

In one example, the master BS is a LTE BS (e.g., eNB), and the secondary BS is a NR BS (e.g., gNB). In one example, the master BS is a NR BS (e.g., gNB), and the secondary BS is a LTE BS (e.g., eNB). In one example, the modification procedure is initiated by the master BS or the secondary BS. When the modification procedure is initiated, the secondary BS transmits the first message including at least one of the secondary BS configuration and the first RRC message to the master BS.

The examples of the process 30 may be applied to the process 40, and are not narrated herein.

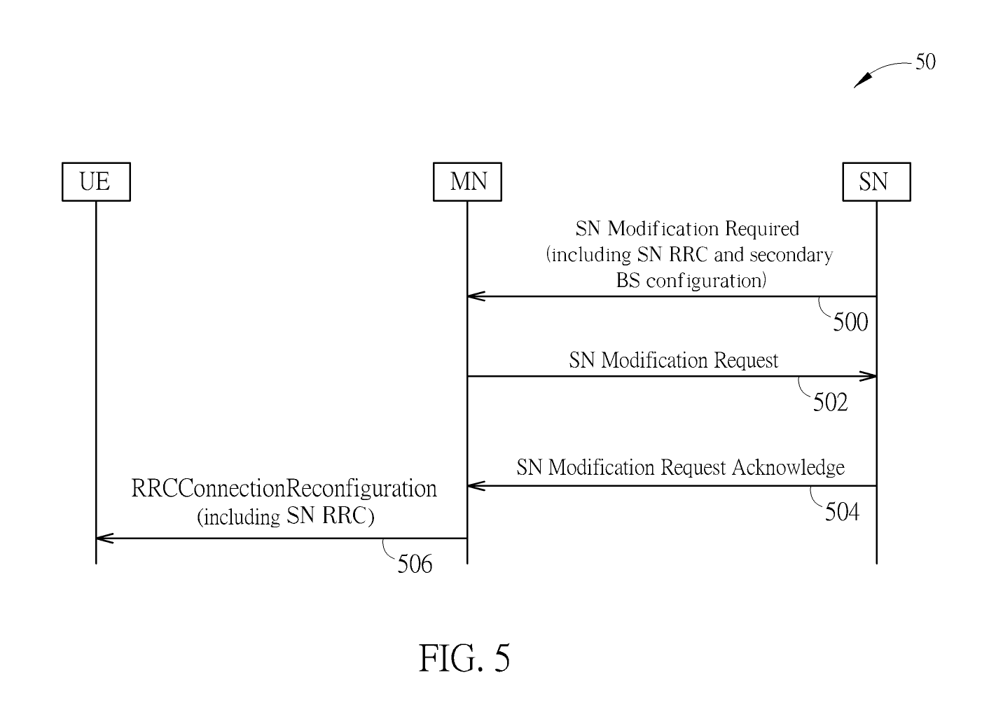

FIG. 5 is a schematic diagram of a modification procedure 50 according to an example of the present invention. Operations of a UE, a MN (e.g., eNB) and a SN (e.g., gNB) in FIG. 5 are described as follows. The UE communicates with the MN via a first RAT (e.g., a LTE RAT), and communicates with the SN via a second RAT (e.g., a NR RAT). The MN communicates with the SN via the second RAT. The SN transmits a SN Modification Required message including a SN RRC message and a secondary BS configuration to the MN (Step 500). The secondary BS configuration includes a drb-ToAddModListSCG. The MN determines whether a modification for the SN RRC message and/or the secondary BS configuration is needed. If the modification for the SN RRC message and/or the secondary BS configuration is needed, the MN transmits a SN Modification Request message including a SCG-ConfigInfo to the SN (Step 502). The SCG-ConfigInfo may include a master BS configuration (e.g., mcg-RB-Config which is the RB configuration of the MN). The SN modifies the SN RRC message and/or the secondary BS configuration to a modified SN RRC message and/or a modified secondary BS configuration according to the SCG-ConfigInfo, respectively. The SN transmits a SN Modification Request Acknowledge message including the modified SN RRC message and/or the modified secondary BS configuration (Step 504). After receiving the SN Modification Request Acknowledge message, the MN transmits a RRCConnectionReconfiguration message including the modified SN RRC message to the UE (Step 506) . If the modification for the SN RRC message and/or the secondary BS configuration is not needed, the MN skips Steps 502 and 504, and transmits a RRCConnectionReconfiguration message including the SN RRC message to the UE (Step 506).

Those skilled in the art should readily make combinations, modifications and/or alterations on the abovementioned description and examples. For example, the skilled person easily makes new embodiments of the BSs based on the embodiments and examples of the UE, and makes new embodiments of the UE based on the embodiments and examples of the BSs. The abovementioned description, steps and/or processes including suggested steps can be realized by means that could be hardware, software, firmware (known as a combination of a hardware device and computer instructions and data that reside as read-only software on the hardware device), an electronic system, or combination thereof. An example of the means may be the communication device 20. Any of the above processes and examples above may be compiled into the program codes 214.

To sum up, the present invention provides a method and related communication device for performing a modification procedure. A secondary BS configuration includes configuration parameters for a master BS to check or understand information in a RRC message received from a secondary BS. Thus, the coordination between the master BS and the secondary BS is improved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A secondary base station (BS) for performing a modification procedure with a master BS, comprising:
a storage device; and
a processing circuit, coupled to the storage device, wherein the storage device stores, and the processing circuit is configured to execute instructions of:
transmitting a first message comprising a first radio resource control (RRC) message and a secondary BS configuration to the master BS, wherein the secondary BS configuration comprises a plurality of configuration parameters;
modifying the secondary BS configuration to a modified secondary BS configuration according to a master BS configuration, when receiving a second message comprising the master BS configuration from the master BS in response to the first message; and
transmitting the modified secondary BS configuration to the master BS.

2. The secondary BS of claim 1, wherein the plurality of configuration parameters comprise a list of data radio bearers (DRBs) for the secondary BS to be added or modified by the secondary BS.

3. The secondary BS of claim 1, wherein the first RRC message comprises a plurality of configurations fora communication device to configure at least one of a Physical layer, a Medium Access Control (MAC) layer and a Radio Link Control (RLC) layer.

4. The secondary BS of claim 1, wherein the instructions further comprise:
modifying the first RRC message to a modified RRC message according to the master BS configuration, when receiving the second message comprising the master BS configuration from the master BS in response to the first message; and
transmitting the modified RRC message to the master BS.

5. The secondary BS of claim 1, wherein the master BS is a long-term evolution (LTE) BS, and the secondary BS is a new radio (NR) BS.

6. The secondary BS of claim 1, wherein the modification procedure is initiated by the master BS or the secondary BS.

7. A master base station (BS) for performing a modification procedure with a secondary BS, comprising:
a storage device; and
a processing circuit, coupled to the storage device, wherein the storage device stores, and the processing circuit is configured to execute instructions of:
receiving a first message comprising a first radio resource control (RRC) message and a secondary BS configuration from the secondary BS, wherein the secondary BS configuration comprises a plurality of configuration parameters;
transmitting a second message comprising a master BS configuration to the secondary BS in response to the first message, when determining that a modification for the secondary BS configuration is needed according to the plurality of configuration parameters; and
receiving a modified secondary BS configuration from the secondary BS in response to the second message.

8. The master BS of claim 7, wherein the plurality of configuration parameters comprise a list of data radio bearers (DRBs) for the secondary BS to be added or modified by the secondary BS.

9. The master BS of claim 7, wherein the first RRC message comprises a plurality of configurations for a communication device to configure at least one of a Physical layer, a Medium Access Control (MAC) layer and a Radio Link Control (RLC) layer.

10. The master BS of claim 7, wherein the instructions further comprise:
generating a second RRC message comprising the first RRC message; and
transmitting the second RRC message to a communication device.

11. The master BS of claim 7, wherein the instructions further comprise:
generating a second RRC message comprising a modified RRC message, wherein the modified RRC message is received from the secondary BS; and
transmitting the second RRC message to a communication device.

12. The master BS of claim 7, wherein the instructions further comprise:
transmitting a third message with a cause value indicating that the modification is needed to the secondary BS.

13. The master BS of claim 7, wherein the master BS is a long-term evolution (LTE) BS, and the secondary BS is a new radio (NR) BS.

14. The master BS of claim 7, wherein the modification procedure is initiated by the master BS or the secondary BS.
